(19) United States
(12) Patent Application Publication
(10) Pub. No.: US 2025/0265362 A1
(43) Pub. Date: Aug. 21, 2025

(54) ACCESS CONTROL METHOD AND APPARATUS FOR LINUX FILE SYSTEM

(71) Applicant: Alipay (Hangzhou) Information Technology Co., Ltd., Hangzhou (CN)

(72) Inventors: Shouye LIU, Hangzhou (CN); Wang YU, Hangzhou (CN); Yan YAN, Hangzhou (CN); Qingsong CHEN, Hangzhou (CN)

(21) Appl. No.: 18/856,272

(22) PCT Filed: Apr. 6, 2023
(86) PCT No.: PCT/CN2023/086406

§ 371 Date: Oct. 11, 2024

(30) Foreign Application Priority Data
Apr. 12, 2022 (CN) 202210381379.X

(51) Int. Cl. G06F 21/62

(52) U.S. Cl. CPC G06F 21/6218

(57) ABSTRACT

An access control method and apparatus for a Linux file system are provided. The method includes: registering a Linux security module in a procedure of starting a Linux operating system. The Linux security module is configured to perform the following operations: calling a signature verification module to obtain configuration information from a signature verification server, where the configuration information is used to record a protected file in the Linux file system and a protection policy for the protected file; and performing file protection on the protected file based on the protection policy. The signature verification module is configured to perform the following operations: verifying a signature of a first user in response to receiving a modification request of the first user for the configuration information; and modifying the configuration information if the verification on the signature of the first user succeeds.

### TECHNICAL FIELD

Embodiments of this disclosure relate to the field of computer technologies, and in particular, to an access control method and apparatus for a Linux file system.

### BACKGROUND

A Linux security module (LSM) is a general access control framework in a Linux kernel. Based on the framework, a security access control function can be implemented.

Most existing security systems based on the Linux security module framework perform access control on all processes. This leads to a very cumbersome access control procedure. In addition, these security systems cannot implement different file access control for different users.

### SUMMARY

This disclosure provides an access control method and apparatus for a Linux file system, to resolve the above-mentioned problem that an access control procedure is cumbersome and different access control cannot be implemented for different users. According to a first aspect, an access control method for a Linux file system is provided and includes: registering a Linux security module in a procedure of starting a Linux operating system. The Linux security module is configured to perform the following operations: calling a signature verification module to obtain configuration information from a signature verification server, where the configuration information is used to record a protected file in the Linux file system and a protection policy for the protected file; and performing file protection on the protected file based on the protection policy. The signature verification module is configured to perform the following operations: verifying a signature of a first user in response to receiving a modification request of the first user for the configuration information; and modifying the configuration information if a verification on the signature of the first user succeeds.

Optionally, the Linux security module is further configured to perform the following operations: receiving a file access request sent by a first process; and when a user corresponding to the first process is a root user, determining whether the first process is a process escaping from a container, and if the first process is the process escaping from the container, rejecting the file access request.

Optionally, a container identifier of a parent process of the first process is recorded in a task structure corresponding to the first process; and the determining whether the first process is a process escaping from a container includes: searching the task structure corresponding to the first process, to obtain the container identifier of the parent process of the first process; and if the container identifier of the parent process of the first process is different from a container identifier of the first process, determining that the first process is the process escaping from the container.

Optionally, the container identifier of the parent process is obtained by using an mnt_mns field of the parent process.

Optionally, the protected file is a user file in the Linux file system.

Optionally, the Linux security module is further configured to perform the following operations: receiving a file access request sent by a second process; and if a user corresponding to the second process is a login user and user permission is root user permission, rejecting the file access request.

Optionally, the Linux security module is further configured to perform the following operation: exporting the protected file and/or the protection policy to a Linux file system interface based on the configuration information.

According to a second aspect, an access control apparatus for a Linux file system is provided and includes a registration unit, configured to register a Linux security module in a procedure of starting a Linux operating system. The Linux security module is configured to perform the following operations: calling a signature verification module to obtain configuration information from a signature verification server, where the configuration information is used to record a protected file in the Linux file system and a protection policy for the protected file; and performing file protection on the protected file based on the protection policy. The signature verification module is configured to perform the following operations: verifying a signature of a first user in response to receiving a modification request of the first user for the configuration information; and modifying the configuration information if the verification on a signature of the first user succeeds.

Optionally, the Linux security module is further configured to perform the following operations: receiving a file access request sent by a first process; and when a user corresponding to the first process is a root user, determining whether the first process is a process escaping from a container, and if the first process is the process escaping from the container, rejecting the file access request.

Optionally, a container identifier of a parent process of the first process is recorded in a task structure corresponding to the first process; and the determining whether the first process is a process escaping from a container includes: searching the task structure corresponding to the first process, to obtain the container identifier of the parent process of the first process; and if the container identifier of the parent process of the first process is different from a container identifier of the first process, determining that the first process is the process escaping from the container.

Optionally, the container identifier of the parent process is obtained by using an mnt_mns field of the parent process.

Optionally, the protected file is a user file in the Linux file system.

Optionally, the Linux security module is further configured to perform the following operations: receiving a file access request sent by a second process; and if a user corresponding to the second process is a login user and user permission is root user permission, rejecting the file access request.

Optionally, the Linux security module is further configured to perform the following operation: exporting the protected file and/or the protection policy to a Linux file system interface based on the configuration information.

According to a third aspect, an access control apparatus for a Linux file system is provided and includes a memory and a processor. The memory stores executable code. The processor is configured to execute the executable code to implement the method according to the first aspect.

According to a fourth aspect, a computer-readable storage medium is provided. The computer-readable storage medium stores executable code. When the executable code is executed, the method according to the first aspect can be implemented.

According to a fifth aspect, a computer program product is provided and includes executable code. When the executable code is executed, the method according to the first aspect can be implemented.

In this disclosure, file protection by the Linux security module is implemented based on the configuration information. A user can configure or modify the configuration information based on a requirement of the user. Therefore, the access control method provided in this disclosure can implement customized file protection based on the requirement of the user. In addition, only a user whose signature verification succeeds can modify the configuration information. That is, if verification on a signature of any user (including a root user) by the signature verification server does not succeed, the configuration information cannot be modified. Therefore, the access control method provided in this disclosure can provide reliable customized file protection.

### BRIEF DESCRIPTION OF DRAWINGS

To describe the technical solutions in the embodiments of this disclosure or in the background more clearly, the following describes the accompanying drawings in the embodiments of this disclosure.

FIG. 1 is a schematic flowchart of an access control method for a Linux file system according to an embodiment of this disclosure;

FIG. 2 is a schematic flowchart of a method for exporting a file protection list to an interface according to an embodiment of this disclosure;

FIG. 3 is a schematic flowchart of another access control method for a Linux file system according to an embodiment of this disclosure;

FIG. 4 is a schematic structural diagram of an access control apparatus for a Linux file system according to an embodiment of this disclosure; and

FIG. 5 is a schematic structural diagram of another access control apparatus for a Linux file system according to an embodiment of this disclosure.

### DESCRIPTION OF EMBODIMENTS

The following clearly and comprehensively describes the technical solutions in the embodiments of this disclosure with reference to the accompanying drawings in the embodiments of this disclosure. Clearly, the described embodiments are merely some rather than all of the embodiments of this disclosure.

A namespace can provide a resource isolation solution for an operating system. Resources in the namespace are invisible to another namespace. In a container technology, resource isolation is implemented by using this feature of the namespace. Different containers can belong to different namespaces. Based on the container technology, data of different users can be isolated into different containers, so that a user cannot access data in another container.

A Linux security module is a general access control framework in a Linux kernel. Based on the framework, a security access control function can be implemented.

The Linux security module adds a security domain field to a key data structure in the kernel. The field is set and managed by a specific security module, and stores security information of the key data structure in the kernel. The security information is an identifier of a system resource, and is important information for implementing security mechanisms of most access control policies.

The Linux security module provides a hook function interface for the security module to set and manage the security domain field in the data structure in the kernel. Before a system accesses a key resource object, the Linux security module can first call and execute a hook function, to implement a security policy formulated by a user. More than 100 hook functions are preset in an architecture of the Linux security module, covering seven types of resource objects in the kernel.

Currently, a representative security system under the Linux security module framework is SELinux. SELinux can provide a mandatory access control model. SELinux performs control access on all processes. This leads to a very cumbersome access control procedure. In addition, under the SELinux framework, customized file access control cannot be implemented. That is, an existing security system cannot implement different access control for different users.

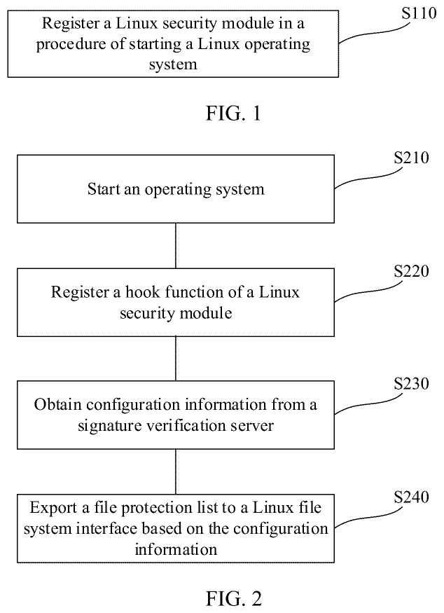

To resolve the above-mentioned problem, this disclosure provides an access control method for a Linux file system. FIG. 1 is a schematic flowchart of an access control method for a Linux file system according to an embodiment of this disclosure. The method shown in FIG. 1 includes step S110.

Step S110: Register a Linux security module in a procedure of starting a Linux operating system (OS).

The Linux security module can be a module in the Linux file system. For example, the Linux security module can be implemented by using an LSM module. The Linux security module can be, for example, a kernel object (ko). In other words, the Linux security module can include a file whose suffix is.ko.

The Linux security module can be registered in an initialization (init) procedure of starting the operating system. Registration of the Linux security module can include registration of a hook function.

The Linux file system can further include a signature verification server and a signature verification module.

The signature verification server can be configured to store or maintain configuration information. The configuration information can be used to record a protected file in the Linux file system and a protection policy for the protected file. The Linux security module can perform file protection on the protected file based on the protection policy in the configuration information.

The protected file and/or the protection policy can be recorded in the configuration information by using a list. In this case, the configuration information can include a file protection list.

A filename recorded in the configuration information can be a full-path filename, so that the protected file can be accurately determined.

The protection policy included in the configuration information can also be referred to as a protection mode. For example, the protection policy can include which user or users can access the protected file, which access permission (for example, one or more of “display”, “open”, “search”, “delete”, “add”, “modify”, and the like) can be granted to a user who can access the file, and so on. If no access permission for the protected file is granted to a user (including a root user) in the configuration information, the Linux security module can protect the file from being accessed by the user.

Optionally, the signature verification server can further implement data forwarding and/or storage. For example, the signature verification server can receive a file uploaded by an agent and store the file in a database. Alternatively, the signature verification server can communicate with an agent and deliver a file to the agent (client side).

The signature verification module can be configured to obtain the configuration information from the signature verification server. In an embodiment, the signature verification module can send a request to the signature verification server, so that the signature verification server verifies whether a current device is securely started. If the verification succeeds, the signature verification server can return the configuration information to the signature verification module.

The signature verification module can obtain the configuration information from the signature verification server on an appropriate occasion. For example, after the Linux operating system is started, the signature verification module can automatically request initial configuration information from the signature verification server. The signature verification module can be registered in the initialization procedure of starting the Linux operating system, so that the configuration information is automatically obtained after the operating system is started.

The configuration information can be exported to a Linux file system interface. The configuration information can be exported by the Linux security module. For example, the Linux security module can be configured to export the protected file and the protection policy to the Linux file system interface based on the configuration information.

The Linux file system interface can be a system (sys) file system interface. For example, the Linux file system interface can include/sys/security/file_protect/list. The Linux file system interface can be understood as a front end. A function that can be completed by the Linux file system interface can further include a function of temporarily modifying the configuration information. Temporarily modified configuration information can also be referred to as a whitelist. That is, the interface can implement configuration of the whitelist.

FIG. 2 is a schematic flowchart of a method for exporting a file protection list to an interface according to an embodiment of this disclosure. The method shown in FIG. 2 can include step S210˜step S240.

Step S210: Start the operating system.

In the initialization procedure of starting the operating system, the Linux security module and the signature verification module can be registered. A procedure of registering the Linux security module can include step S220.

Step S220: Register a hook function of the Linux security module.

Step S230: Obtain the configuration information from the signature verification server.

In an embodiment, after the current device is securely started, a request for obtaining the configuration information can be sent to the signature verification server by using the signature verification module. The signature verification server can verify the request. After the verification succeeds, the signature verification server can return the initial configuration information to the current device. The initial configuration information can be passed to the Linux security module after being verified.

Step S240: The Linux security module can export the file protection list to the Linux file system interface based on the obtained configuration information.

The configuration information can be modified. The modification can include, for example, adding the protected file to or deleting the protected file from the configuration information, and modifying permission of a user for the protected file.

In an embodiment, the signature verification server can receive a file uploaded by an agent and add the file to the configuration information.

In another embodiment, an authorized user can temporarily modify the configuration information. For example, the signature verification module can verify a signature of a first user in response to receiving a modification request of the first user for the configuration information, to determine whether the first user is an authorized user. If the verification on the signature of the first user succeeds, the first user is an authorized user, and the configuration information can be modified based on the request of the first user.

It should be noted that the modified configuration information can be configuration information displayed on an interface (for example, a protected file whitelist), or can be configuration information stored in the signature verification server. In addition, a specific signature verification method is not limited in this disclosure.

Through verification on the signature of the first user, an unauthorized user can be prevented from modifying the configuration information, to improve reliability of content of the configuration information, and improve reliability of file protection.

As described above, file protection by the Linux security module is implemented based on the configuration information. A user can configure or modify the configuration information based on a requirement of the user. For example, the user can protect, by using the Linux security module provided in this disclosure, all or some of files that the user expects to protect. Alternatively, the user can control access permission of another user (including a root user) for a file or some files. Therefore, the access control method provided in this disclosure can implement customized file protection based on the requirement of the user.

In addition, only a user whose signature verification succeeds can modify the configuration information. That is, if verification on a signature of any user (including a root user) by the signature verification server does not succeed, the configuration information cannot be modified. Therefore, the access control method provided in this disclosure can provide reliable customized file protection.

Further, the method provided in this disclosure and a related access control method (for example, SELinux) are not mutually exclusive. Therefore, the related access control method can be combined with the method provided in this disclosure, to provide additional protection in the related access control method.

It can be learned from the above-mentioned descriptions that in this disclosure, access permission of the root user can be set by using the configuration information, so that access to the file by the root user can be rejected. In some cases, access permission for the file is open to the root user. However, the permission of the root user may be obtained by another non-root user by using illegal permission. Consequently, data of the user is illegally obtained by another user. For this file, this disclosure provides a method, to identify whether the permission of the root user is illegally obtained.

In an embodiment, if a process that sends a file access request is a process escaping from a container and a corresponding user is a root user, the Linux security module can reject the file access request. It can be understood that a process escaping from a container is not a process created by a native root user. If a process or a parent process of a process is created in a container, but a user corresponding to the process illegally obtains root user permission, it can be considered that the process is a process escaping from the container.

For example, the Linux security module can receive a file access request sent by a first process; and when a user corresponding to the first process is a root user, can determine whether the first process is a process escaping from a container, and if the first process is a process escaping from the container, reject the file access request.

When a process is created in a container environment, a flag can be added to the process. The flag can be, for example, a container identifier corresponding to the process. Subsequently, it can be determined, based on the flag, whether the process is an escaping process.

For example, if a process is created in a container environment, a first field can be added to a structure of the process. The first field can be used to store a flag. The flag can be obtained, for example, by using a container identifier. The structure of the process can be, for example, a task_struct structure. The container identifier can be, for example, an mnt_ns field, and the first field can be obtained by copying the mnt_ns field. The first field can be, for example, denoted as original_mnt_mns.

A child process needs to inherit a first field of a parent process. In addition, once the first field is set, the first field cannot be modified or reset. Therefore, even if the first process or a child process of the first process escapes, the first field always exists and is not modified, so that the first field can be used to determine an escape status of the process. For example, if the process escapes to another container (for example, escapes to a host) and a new process is created, this can be discovered by using the first field. For example, a container identifier of a parent process is stored in a first field in a task structure corresponding to the first process. If a container identifier of the first process is different from the container identifier of the parent process, it indicates that the first process and the parent process are located in different containers, that is, the first process is an escaping process.

In an implementation, when the first process (for example, a do_fork() function) is created, it can be determined whether the parent process of the created first process is a process in a container. For example, when pid_ns is not equal to init_pid_ns (pid_ns!=init_pid_ns), the parent process is a process in a container. If the parent process is a process in a container, the container identifier mnt_ns in task_struct of the parent process is copied to the first field in task_struct of the first process. When the first process sends the file access request to apply for access to an upper protected file, the Linux security module can determine, based on original_mnt_mns in task_struct of the first process and the container identifier (current->mnt_mns) of the first process, to accept or reject the file access request of the first process. For example, if original_mnt_mns is different from current->mnt_mns, it is determined that the first process is an escaping process, and the file access request of the first process is rejected.

In an implementation, the Linux security module receives a file access request sent by a second process; and if a user corresponding to the second process is a login user and user permission is root user permission, can reject the file access request. The login user can be an external or remote login user. For example, the login user can be a user who logs in by using an sshd command or through ECS remote login.

It can be understood that if it is determined that the user is a login user, the file access request can be rejected even if the user permission of the user is the root user permission.

Each process can store a login user identifier (login user id, UID) in a login user field. The login user field can be, for example, a field in a proc structure of a process. The login user field can be, for example, a/proc/self/loginuid field. The login user field can be a part of each process on the system. The login user field can be set only once. When a user logs in to the system, a login program can set a login user field for an initial login process. Each process that forks from the initial login process and executes (exec) can automatically inherit the login user field of the initial login process.

When a login user field of the second process is set and the user corresponding to the second process has the root user permission, the second process may illegal obtain the root user permission. Therefore, the Linux security module can reject the file access request of the second process.

It should be noted that the protected file in this disclosure can be a user file in the Linux file system. There are many directories created by users and root users in a/home directory of the Linux operating system. The user can create a directory (folder) for the user and store a file in a corresponding directory. The directory created by the root user includes a non-service file and does not include a user-sensitive file. The directory created by the user includes a user file, and the user file includes service data of the user. The service data includes sensitive information of the user. The sensitive information of the user needs to be isolated (that is, cannot be arbitrarily accessed by another user). The Linux security module can determine, based on a full path of a filename, whether the file needs to be protected.

The following describes in detail how the Linux security module implements permission management of the protected file.

In an embodiment, in the method provided in this disclosure, the protected file can be protected at a file system level based on the Linux security module. Most of related index node operations are performed at a virtual file system (VFS) layer, and no modification needs to be made to an underlying file system (for example, a fourth extended file system (ext4)). For all files in the configuration information, when a specific operation is performed, the Linux security module can determine, in the hook function, whether a user who applies for access is authorized.

Before the Linux security module is executed to perform check, permission check (rwx) of the Linux system can be performed. When the rwx check succeeds, the Linux security module is called to perform security check. It can be understood that the Linux security module can provide additional check in addition to the check provided by the Linux system.

The Linux security module can call the hook function to perform security check. The hook function can be registered when the Linux security module is registered.

In an implementation, the hook function can first check whether the file falls within the configuration information. In an example in which the configuration information stores a full path of the protected file, the hook function can check whether the full path of the file falls within the configuration information. If the file does not belong to one or more protected files recorded in the configuration information, there can be direct return to the Linux security module, that is, no protection or access control is performed on the file. If the file belongs to one or more protected files recorded in the configuration information, the Linux security module can read a protection policy for the file from the configuration information. Based on the protection policy, a corresponding operation is called based on operation permission management by the Linux security module.

Examples of operation permission management and related hook functions are as follows:

### (1) File Open Permission Management

There is an open system call: SYSCALL_DEFINE3(open, const char_user *, filename, int, flags, umode_t, mode)--->ksys_open()--->do_sys_open() . . . --->vfs_open()--->do_dentry_open()---22 security_file_open(struct file *file).

There is an openat system call: SYSCALL DEFINE4(openat, int, dfd, const char_user *, filename, int, flags, umode_t, mode)---22 do_sys_open()---> . . . ---->vfs_open()--->do_dentry_open()--->security_file_open(struct file *file).

### (2) File Owner Permission Management

There is an fchownat system call: SYSCALL_DEFINE5(fchownat, int, dfd, const cha _user *, filename, uid_t, user,gid_t, group, int, flag)--->do_fchownat()--->chown_common--->security_path_chown(const struct path *path, kuid_t uid, kgid_t gid).

### (3) File Hiding

There is a getdents system call: SYSCALL_DEFINE3(getdents, unsigned int, fd,struct linux_dirent_user *, dirent, unsigned int, count)--->iterate_dir(f.file, &buf.ctx)--->security_file_permission(file, MAY_READ).

It can be understood that only some hook functions may be taken over in this disclosure. This is more lightweight than SELinux in which all hook functions in a set are taken over.

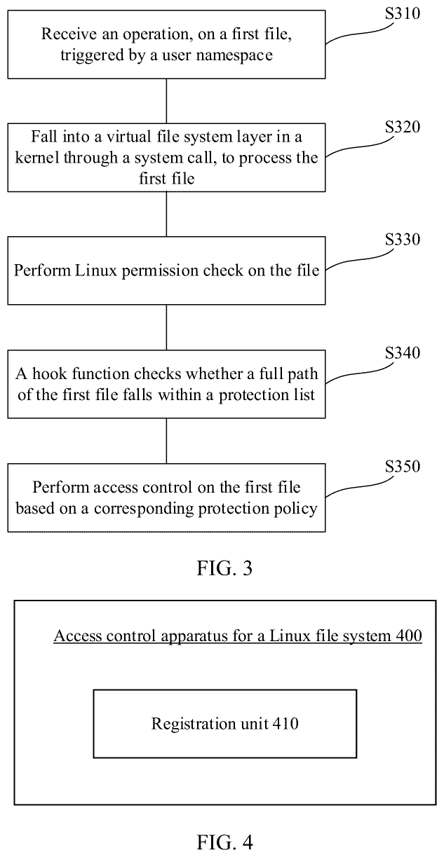

FIG. 3 is a schematic flowchart of an access control method for a Linux file system according to an embodiment of this disclosure. The Linux file system can include a front end, a back end LSM module, a signature verification server, and a signature verification module. The method shown in FIG. 3 includes step S310˜step S350.

Step S310: Receive an operation, on a first file, triggered by a user namespace.

Step S320: Fall into a VFS layer in a kernel through a system call, to process the first file. Step S330: Perform Linux permission check on the file.

After the permission check succeeds, hook function check of a Linux security module can be performed. In this case, the Linux security module can be called into a hook function.

Step S340: The hook function checks whether a full path of the first file falls within a protection list.

If the first file falls outside a range of the protection list, there can be direct return to the Linux security module, that is, no access control is performed on the first file. If the first file falls within a range of the protection list, a subsequent operation is then performed. The Linux security module can read a protection policy for the first file from the protection list. The policy can include a protection policy for the first file, for example, specifying a user who can perform reading/writing, allowing only some users to perform reading/writing, or preventing any user (including a root user) other than an owner from performing reading/writing. The protection list can be obtained by using a Linux file system interface.

Step S350: Perform access control on the first file based on the corresponding protection policy.

When the first file falls within the protection range of the protection list, an additional permission control and management system of the Linux security module can perform a corresponding operation on the first file based on the protection policy.

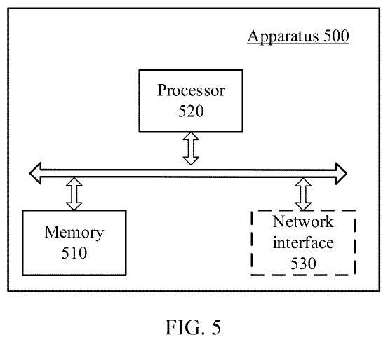

With reference to FIG. 1 to FIG. 3, the method embodiments provided in this disclosure are described above. With reference to FIG. 4 and FIG. 5, the following describes apparatus embodiments provided in this disclosure. It can be understood that the apparatus embodiments correspond to the method embodiments. For content that is not described in detail in the apparatus embodiments, refer to the method embodiments.

FIG. 4 is a schematic structural diagram of an access control apparatus for a Linux file system 400 according to an embodiment of this disclosure. The access control apparatus for a Linux file system 400 includes a registration unit 410.

The registration unit 410 is configured to register a Linux security module in a procedure of starting a Linux operating system. The Linux security module is configured to perform the following operations: calling a signature verification module to obtain configuration information from a signature verification server, where the configuration information is used to record a protected file in the Linux file system and a protection policy for the protected file; and performing file protection on the protected file based on the protection policy. The signature verification module is configured to perform the following operations: verifying a signature of a first user in response to receiving a modification request of the first user for the configuration information; and modifying the configuration information if the verification on the signature of the first user succeeds.

Optionally, the Linux security module is further configured to perform the following operations: receiving a file access request sent by a first process; and when a user corresponding to the first process is a root user, determining whether the first process is a process escaping from a container, and if the first process is a process escaping from the container, rejecting the file access request.

Optionally, a container identifier of a parent process of the first process is recorded in a task structure corresponding to the first process; and the determining whether the first process is a process escaping from a container includes: searching the task structure corresponding to the first process, to obtain the container identifier of the parent process of the first process; and if the container identifier of the parent process of the first process is different from a container identifier of the first process, determining that the first process is a process escaping from the container.

Optionally, the container identifier of the parent process is obtained by using an mnt_mns field of the parent process.

Optionally, the protected file is a user file in the Linux file system.

Optionally, the Linux security module is further configured to perform the following operations: receiving a file access request sent by a second process; and if a user corresponding to the second process is a login user and user permission is root user permission, rejecting the file access request.

Optionally, the Linux security module is further configured to perform the following operation: exporting the protected file and/or the protection policy to a Linux file system interface based on the configuration information.

FIG. 5 is a schematic structural diagram of another access control apparatus for a Linux file system according to an embodiment of this disclosure. The apparatus 500 can be, for example, a computing device with a computing function. For example, the apparatus 500 can be a mobile terminal or a server. The apparatus 500 can include a memory 510 and a processor 520. The memory 510 can be configured to store executable code. The processor 520 can be configured to execute the executable code stored in the memory 510, to implement the steps in the methods described above. In some embodiments, the apparatus 500 can further include a network interface 530, and data exchange between the processor 520 and an external device can be implemented by using the network interface 530.

All or some of the above-mentioned embodiments can be implemented by using software, hardware, firmware, or any other combination. When software is used for implementation, all or some of the above-mentioned embodiments can be implemented in a form of a computer program product. The computer program product includes one or more computer instructions. When the computer program instructions are loaded and executed on a computer, all or some of the procedures or functions according to the embodiments of this disclosure are generated. The computer can be a general-purpose computer, a dedicated computer, a computer network, or another programmable apparatus. The computer instructions can be stored in a computer-readable storage medium, or can be transmitted from a computer-readable storage medium to another computer-readable storage medium. For example, the computer instructions can be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium can be any usable medium accessible by the computer, or a data storage device, for example, a server or a data center, into which one or more usable media are integrated. The usable medium can be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art can be aware that the example units, algorithms, and steps described with reference to the embodiments of this disclosure can be implemented by electronic hardware or a combination of computer software and electronic hardware. Whether the functions are performed by hardware or software depends on particular applications and design constraints of the technical solutions. A person skilled in the art can use different methods to implement the described functions for each particular application, but it should not be considered that the implementation goes beyond the scope of this disclosure.

In the several embodiments provided in this disclosure, it should be understood that the disclosed system, apparatus, and method can be implemented in other manners. For example, the apparatus embodiments described above are merely examples. For example, division into the units is merely logical function division and may be other division in an actual implementation. For example, a plurality of units or components can be combined or integrated into another system, or some features may be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

The units described as separate parts may or may not be physically separate, and parts displayed as units may or may not be physical units, that is, may be located at one location, or may be distributed on a plurality of network units. Some or all of the units can be selected based on actual requirements to achieve the objectives of the solutions in the embodiments.

In addition, functional units in the embodiments of this disclosure can be integrated into one processing unit, each of the units can exist alone physically, or two or more units can be integrated into one unit.

The above-mentioned descriptions are merely specific implementations of this disclosure, but the protection scope of this disclosure is not limited thereto. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. An access control method for a Linux file system, comprising:
registering a Linux security module in a procedure of starting a Linux operating system, wherein
the Linux security module is configured to perform the following operations:
calling a signature verification module to obtain configuration information from a signature verification server, wherein the configuration information is used to record a protected file in the Linux file system and a protection policy for the protected file; and
performing file protection on the protected file based on the protection policy; wherein
the signature verification module is configured to perform the following operations:
verifying a signature of a first user in response to receiving a modification request of the first user for the configuration information; and
modifying the configuration information if a verification on the signature of the first user succeeds.

2. The method according to claim 1, wherein the Linux security module is further configured to perform the following operations:
receiving a file access request sent by a first process; and
when a user corresponding to the first process is a root user, determining whether the first process is a process escaping from a container, and upon determining that the first process is the process escaping from the container, rejecting the file access request.

3. The method according to claim 2, wherein a container identifier of a parent process of the first process is recorded in a task structure corresponding to the first process; and
the determining whether the first process is a process escaping from a container comprises:
searching the task structure corresponding to the first process, to obtain the container identifier of the parent process of the first process; and
upon determining that the container identifier of the parent process of the first process is different from a container identifier of the first process, determining that the first process is the process escaping from the container.

4. The method according to claim 3, wherein the container identifier of the parent process is obtained by using an mnt_mns field of the parent process.

5. The method according to claim 1, wherein the protected file is a user file in the Linux file system.

6. The method according to claim 1, wherein the Linux security module is further configured to perform the following operations:
receiving a file access request sent by a second process; and
upon determining that a user corresponding to the second process is a login user and user permission is root user permission, rejecting the file access request.

7. The method according to claim 1, wherein the Linux security module is further configured to perform the following operation: exporting the protected file and/or the protection policy to a Linux file system interface based on the configuration information.

8-15. (canceled)

16. A computing device, comprising a memory and a processor, wherein the memory stores executable code, and when executing the executable code, the processor is caused to perform an access control method for a Linux file system, the method comprising:
registering a Linux security module in a procedure of starting a Linux operating system; wherein
the Linux security module is configured to perform the following operations:
calling a signature verification module to obtain configuration information from a signature verification server, wherein the configuration information is used to record a protected file in the Linux file system and a protection policy for the protected file; and
performing file protection on the protected file based on the protection policy; wherein
the signature verification module is configured to perform the following operations:
verifying a signature of a first user in response to receiving a modification request of the first user for the configuration information; and
modifying the configuration information if a verification on the signature of the first user succeeds.

17. The computing device according to claim 16, wherein the Linux security module is further configured to perform the following operations:
receiving a file access request sent by a first process; and
when a user corresponding to the first process is a root user, determining whether the first process is a process escaping from a container, and upon determining that the first process is the process escaping from the container, rejecting the file access request.

18. The computing device according to claim 17, wherein a container identifier of a parent process of the first process is recorded in a task structure corresponding to the first process; and
the determining whether the first process is a process escaping from a container comprises:
searching the task structure corresponding to the first process, to obtain the container identifier of the parent process of the first process; and
upon determining that the container identifier of the parent process of the first process is different from a container identifier of the first process, determining that the first process is the process escaping from the container.

19. The computing device according to claim 18, wherein the container identifier of the parent process is obtained by using an mnt_mns field of the parent process.

20. The computing device according to claim 16, wherein the protected file is a user file in the Linux file system.

21. The computing device according to claim 16, wherein the Linux security module is further configured to perform the following operations:
receiving a file access request sent by a second process; and
upon determining that a user corresponding to the second process is a login user and user permission is root user permission, rejecting the file access request.

22. The computing device according to claim 16, wherein the Linux security module is further configured to perform the following operation: exporting the protected file and/or the protection policy to a Linux file system interface based on the configuration information.
